(19) United States
(12) Patent Application Publication
(10) Pub. No.: US 2021/0094212 A1
(43) Pub. Date: Apr. 1, 2021

(54) REVERSE ROTATION CONDITION ESTIMATING APPARATUS, REVERSE ROTATION CONDITION ESTIMATING METHOD AND INJECTION MOLDING MACHINE

(71) Applicant: FANUC CORPORATION, Minamitsuru-gun (JP)

(72) Inventor: Atsushi HORIUCHI, Minamitsuru-gun (JP)

(21) Appl. No.: 17/026,001

(22) Filed: Sep. 18, 2020

(30) Foreign Application Priority Data
Sep. 27, 2019 (JP) 2019-177164

(51) Int. Cl. B29C 45/77; G06K 9/62; G06N 20/00

(52) U.S. Cl. CPC B29C 45/77; G06K 9/6256; G06N 20/00; B29C 2945/76498; B29C 2945/76665; B29C 2945/7601; B29C 2945/76066; B29C 2945/76187

(57) ABSTRACT

A reverse rotation condition estimating apparatus includes: a learning model storage unit for storing a learning model for estimating reverse rotation conditions; an acquisition unit for acquiring a predetermined time series data set supplied from an injection molding machine at least during a pressure reducing step; and an estimation unit for estimating the reverse rotation conditions using the predetermined time series data set acquired by the acquisition unit and the learning model stored in the learning model storage unit.

### CROSS-REFERENCE TO RELATED APPLICATION

This application is based upon and claims the benefit of priority from Japanese Patent Application No. 2019-177164 filed on Sep. 27, 2019, the contents of which are incorporated herein by reference.

### BACKGROUND OF THE INVENTION

### Field of the Invention

The present invention relates to a reverse rotation condition estimating apparatus, a reverse rotation condition estimating method and an injection molding machine.

### Description of the Related Art

Japanese Laid-Open Patent Publication No. 2014-058066 discloses a configuration in which, after measuring a predetermined injection material in a metering process, the rotation of a screw is stopped and then the screw is rotated in reverse under a condition in which the axial position of the screw is maintained. In Japanese Laid-Open Patent Publication No. 2014-058066, an angle of rotation required for a reverse flow of volume equivalent to the volume of an injection material corresponding to the closing stroke of a check ring is calculated, and the screw is rotated in reverse by the thus calculated rotation angle, whereby variations in metering are reduced.

### SUMMARY OF THE INVENTION

However, in the injection molding machine described in Japanese Laid-Open Patent Publication No. 2014-058066, the rotation amount when the screw is rotated in reverse cannot always be set appropriately. For example, in the case that air enters the cylinder from the outside through the nozzle, there may be cases in which a satisfactory molded product cannot be obtained.

It is therefore an object of the present invention to provide a reverse rotation condition estimating apparatus, a reverse rotation condition estimating method, and an injection molding machine that can favorably estimate the reverse rotation conditions of the screw of an injection molding machine.

According to one aspect of the invention, there is provided a reverse rotation condition estimating apparatus for estimating reverse rotation conditions of an injection molding machine, the injection molding machine including a cylinder into which a resin is supplied and a screw configured to move forward and rearward and rotate inside the cylinder, the injection molding machine being configured to perform at least a metering step of performing metering of the resin while the resin is being melted inside the cylinder, by causing the screw to be moved rearward to a predetermined metering position while being forwardly rotated and a pressure reducing step of reducing a pressure of the resin by rotating the screw in reverse based on the reverse rotation conditions that are predetermined, the reverse rotation condition estimating apparatus including: a learning model storage unit configured to store a learning model configured to estimate the reverse rotation conditions; an acquisition unit configured to acquire a predetermined time series data set supplied from the injection molding machine at least during the pressure reducing step; and an estimation unit configured to estimate the reverse rotation conditions using the predetermined time series data set acquired by the acquisition unit and the learning model stored in the learning model storage unit.

According to another aspect of the invention, an injection molding machine is equipped with the reverse rotation condition estimating apparatus described above.

According to still another aspect of the invention, there is provided a reverse rotation condition estimating method of estimating reverse rotation conditions of an injection molding machine, the injection molding machine including a cylinder into which a resin is supplied and a screw configured to move forward and rearward and rotate inside the cylinder, the injection molding machine being configured to perform at least a metering step of performing metering of the resin while the resin is being melted inside the cylinder, by causing the screw to be moved rearward to a predetermined metering position while being forwardly rotated and a pressure reducing step of reducing a pressure of the resin by rotating the screw in reverse based on reverse rotation conditions that are predetermined, the reverse rotation condition estimating method including: an acquisition step of acquiring a predetermined time series data set supplied from the injection molding machine at least during the pressure reducing step; and a step of estimating the reverse rotation conditions using the predetermined time series data set acquired at the acquisition step and a learning model configured to estimate the reverse rotation conditions.

According to the present invention, it is possible to provide a reverse rotation condition estimating apparatus, a reverse rotation condition estimating method, and an injection molding machine, which can favorably estimate the reverse rotation conditions of the screw of the injection molding machine.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a block diagram showing a reverse rotation condition estimating apparatus according to an embodiment;

FIG. 2 is a side view showing an injection molding machine according to an embodiment;

FIG. 3 is a schematic view showing an injection unit provided in the injection molding machine according to the embodiment;

FIG. 4 is a block diagram showing a control device provided in the injection molding machine according to the embodiment;

FIG. 5 is a block diagram showing the reverse rotation condition estimating apparatus (learning mode) according to the embodiment;

FIGS. 6A, 6B, and 6C are tables showing examples of reverse rotation conditions set when machine learning is performed;

FIG. 7 is a block diagram showing the reverse rotation condition estimating apparatus (estimation mode) according to one embodiment;

FIGS. 8A, 8B, and 8C are diagrams showing examples of tables;

FIG. 9 is a diagram showing an example of display on a display unit;

FIG. 10 is a flowchart showing an example of the operation of the reverse rotation condition estimating apparatus (learning mode) according to the embodiment;

FIG. 11 is a flowchart showing an example of the operation of the injection molding machine according to the embodiment;

FIG. 12 is a flowchart showing an example of the operation of the reverse rotation condition estimating apparatus (estimation mode) according to the embodiment;

FIG. 13 is a flowchart showing an example of the operation of the injection molding machine according to the embodiment; and

FIGS. 14A, 14B, 14C, 14D, and 14E are timing charts showing an example of the operation of the injection molding machine according to the embodiment.

### DESCRIPTION OF THE PREFERRED EMBODIMENTS

A reverse rotation condition estimating apparatus, a reverse rotation condition estimating method, and an injection molding machine according to the present invention will be detailed below by describing a preferred embodiment with reference to the accompanying drawings.

### EMBODIMENT

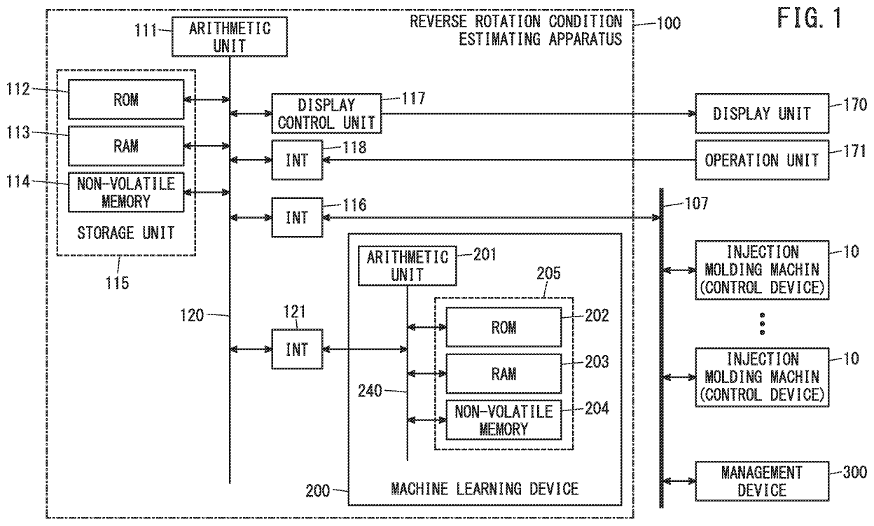

A reverse rotation condition estimating apparatus, a reverse rotation condition estimating method, and an injection molding machine according to an embodiment will be described with reference to FIGS. 1 to 14E. FIG. 1 is a block diagram showing a reverse rotation condition estimating apparatus according to the present embodiment.

As shown in FIG. 1, a reverse rotation condition estimating apparatus 100 can be connected to a plurality of injection molding machines 10 via a network 107. Though in the example described below the reverse rotation condition estimating apparatus 100 and injection molding machines 10 are separately provided, the invention is not limited to this. The reverse rotation condition estimating apparatus 100 may be incorporated in the injection molding machine 10.

The reverse rotation condition estimating apparatus 100 includes an arithmetic unit 111. The arithmetic unit 111 controls the entire reverse rotation condition estimating apparatus 100. As the arithmetic unit 111, a processor such as a CPU (Central Processing Unit) can be used, but it is not limited to this. The arithmetic unit 111 can communicate with the plurality of injection molding machines 10 via an interface 116 and the network 107.

The reverse rotation condition estimating apparatus 100 includes a storage unit 115. The storage unit 115 includes a ROM (Read Only Memory) 112, a RAM (Random Access Memory) 113, and a non-volatile memory 114. As the non-volatile memory 114, for example, a flash memory can be used.

The arithmetic unit 111 can read out a system program and the like stored in the ROM 112 via a bus 120. The arithmetic unit 111 controls the whole reverse rotation condition estimating apparatus 100 according to the system program and the like. The RAM 113 can store temporary calculation data, display data, and the like.

The non-volatile memory 114 can store data and the like supplied from the injection molding machine 10 via the network 107 and others. Further, the non-volatile memory 114 can store a program and the like for operating the reverse rotation condition estimating apparatus 100. Further, the non-volatile memory 114 can store data and the like input by a user or the like using an operation unit 171 described later. The programs, data, etc. stored in the non-volatile memory 114 can be expanded on the RAM 113 at the time of running or use.

A display unit 170 can be connected to the reverse rotation condition estimating apparatus 100. The reverse rotation condition estimating apparatus 100 further includes a display control unit 117. The display control unit 117 can convert digital signals such as numerical data, graphic data and others into raster signals for display or the like, and output the raster signals or the like to the display unit 170. The display unit 170 can display numerical values, figures and the like based on the raster signals or the like supplied from the display control unit 117. The display control unit 117 can display the reverse rotation conditions estimated by an aftermentioned estimation unit 220, on the display unit 170. The display unit 170 may be configured of, for example, a liquid crystal display or the like, but is not limited to this.

An operation unit 171 can be connected to the reverse rotation condition estimating apparatus 100. The operation unit 171 may include, for example, a keyboard, a mouse and the like, but is not limited to this. The operation unit 171 can be configured of an unillustrated touch panel (touch screen) provided on the screen of the display unit 170. The user can give a command to the reverse rotation condition estimating apparatus 100 via the operation unit 171. A command or the like given by operating the operation unit 171 is input to the reverse rotation condition estimating apparatus 100 via the interface 118.

The reverse rotation condition estimating apparatus 100 can communicate with a management device 300 via the interface 116 and the network 107.

The reverse rotation condition estimating apparatus 100 further includes a machine learning device 200. The machine learning device 200 includes an arithmetic unit 201. The arithmetic unit 201 controls the whole machine learning device 200. The arithmetic unit 201 can be configured of a processor such as a CPU, but is not limited to this. For example, the arithmetic unit 201 can be configured of an ASIC (Application Specific Integrated Circuit), a GPU (Graphics Processing Unit), or the like. A bus 240 provided in the machine learning device 200 is connected to the bus 120 connected to the aforementioned arithmetic unit 111 via an interface 121.

The machine learning device 200 further includes a storage unit 205. The storage unit 205 includes a ROM 202, a RAM 203, and a non-volatile memory 204. As the non-volatile memory 204, for example, a flash memory may be used.

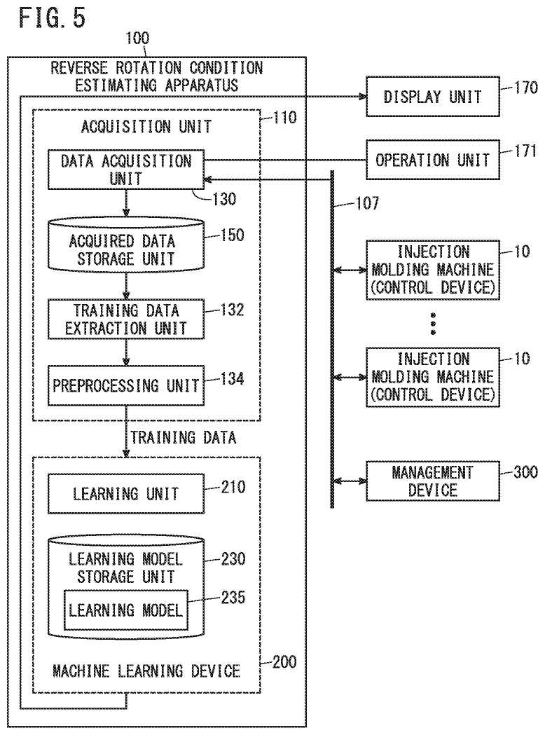

The arithmetic unit 201 can read out the system program and the like stored in the ROM 202 via the bus 240. The RAM 203 can store temporary data and the like in machine learning. A learning model 235 (see FIG. 5) and the like can be stored in the non-volatile memory 204.

The data and the like individually supplied from the multiple injection molding machines 10 can be input to the machine learning device 200 via the interfaces 116 and 121. The data and the like supplied to the machine learning device 200 from each of the multiple injection molding machines 10 include predetermined time series data (data sets) described later. The machine learning device 200 can output reverse rotation conditions to each of the multiple injection molding machines 10 via the interfaces 116 and 121 and the network 107. The optimal reverse rotation conditions for one injection molding machine 10 are not always optimal for another injection molding machine 10. Therefore, the machine learning device 200 can separately estimate the optimum reverse rotation conditions for each of the multiple injection molding machines 10. The reverse rotation conditions specify at least one of the rotation amount of the screw 28, the rotational acceleration of the screw 28, the rotational speed of the screw 28, and the rotation time of the screw 28.

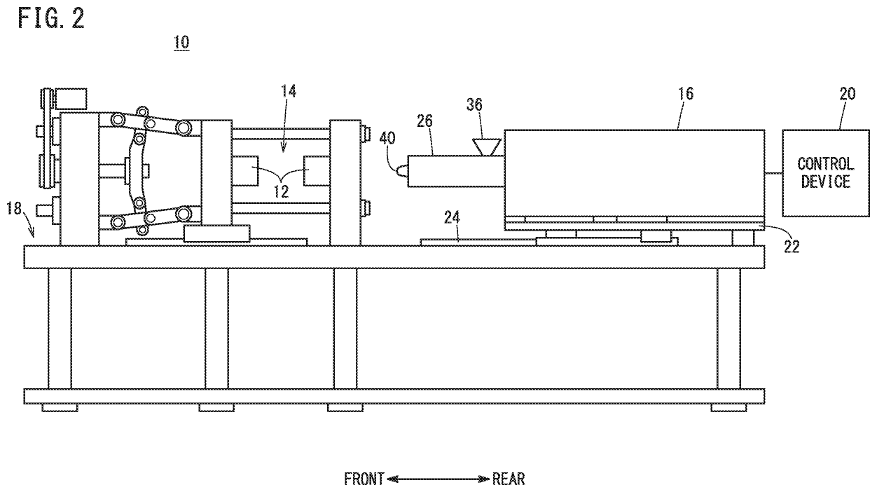

FIG. 2 is a side view showing the injection molding machine according to the present embodiment. In order to facilitate description, the left side of the paper surface in FIG. 2 will be regarded as a front direction, and the right side of the paper surface in FIG. 2 will be regarded as a rear direction.

As shown in FIG. 2, the injection molding machine 10 includes a mold clamping unit 14 having a mold 12 that is configured to be opened and closed, and an injection unit 16 that faces toward the mold clamping unit 14 in the front-rear direction. The mold clamping unit 14 and the injection unit 16 are supported on a machine base 18. The injection molding machine 10 further includes a control device 20 that controls the injection unit 16.

The mold clamping unit 14 and the machine base 18 can be configured based on a known technology. Therefore, in the following, description of the mold clamping unit 14 and the machine base 18 will be omitted as appropriate.

The injection unit 16 is supported on a base 22. The base 22 is supported so as to move forward and rearward, by means of a guide rail 24 installed on the machine base 18. For this reason, the injection unit 16 is configured to move forward and rearward on the machine base 18 and can come into contact with and separate away from the mold clamping unit 14.

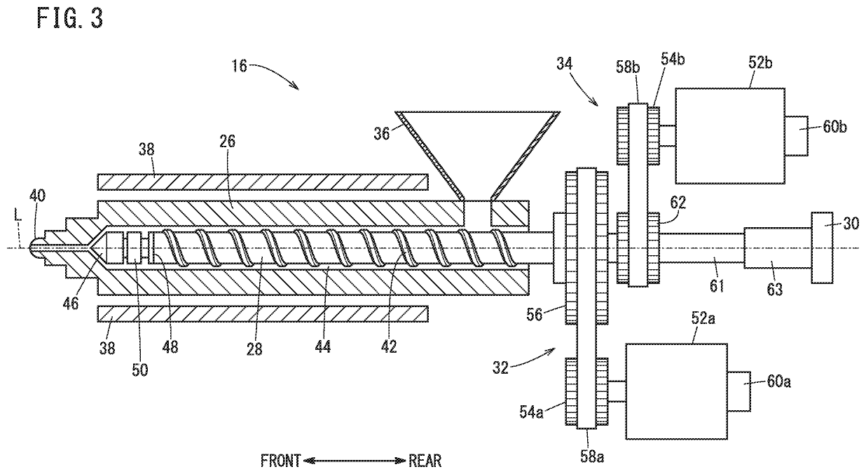

FIG. 3 is a schematic diagram showing the injection unit provided in the injection molding machine according to the present embodiment.

The injection unit 16 is equipped with a tubular-shaped heating cylinder (cylinder) 26. The cylinder 26 has a screw 28 therein. A first drive device 32 and a second drive device 34 are connected to the screw 28.

The axial line of the cylinder 26 and the axial line of the screw 28 coincide with each other on an imaginary line L. Such a system may be referred to as an in-line (in-line screw) system. The injection molding machine to which the in-line system is applied is referred to as an in-line injection molding machine.

As advantages of such an in-line injection molding machine, there may be cited, for example, a point in which the structure of the injection unit 16 is simpler, and a point in which the maintainability thereof is excellent, as compared with other types of injection molding machine. Examples of the other type injection molding machines include a preplasticating type injection molding machine. As shown in FIG. 3, a hopper 36 is provided on a rear side of the cylinder 26. The hopper 36 has a supply port for supplying a resin as the molding material to the cylinder 26. A heater 38 for heating the cylinder 26 is provided along the cylinder 26. A nozzle 40 is formed at the front end of the cylinder 26. The nozzle 40 has an injection port for injecting the resin inside the cylinder 26.

The screw 28 has a spiral flight part 42 along the front-rear direction. The flight part 42, together with the inner wall of the cylinder 26, forms a spiral flow path 44. The spiral flow path 44 guides the resin supplied from the hopper 36 to the cylinder 26, in the forward direction.

A screw head 46 is provided on a front-side end of the screw 28. The screw 28 further includes a check sheet 48. The check sheet 48 is disposed at a distance in the rear direction with respect to the screw head 46. The screw 28 further includes a check ring (a ring for backflow-prevention) 50. The check ring 50 can move back and forth between the screw head 46 and the check sheet 48.

The check ring 50 moves forward relative to the screw 28 when the check ring receives a forward pressure from the resin located on the rear side of the check ring 50. Further, the check ring 50 moves rearward relative to the screw 28 when receiving a rearward pressure from the resin located on the front side of the check ring 50.

In the metering step described below, the resin supplied from the hopper 36 through the supply port to the cylinder 26 is fed and compressed in a frontward direction by the forward rotation of the screw 28 while being melted along the flow path 44. Therefore, the pressure on the rear side of the check ring 50 becomes greater than the pressure on the front side of the check ring 50. When this occurs, the check ring 50 moves forward relative to the screw 28, and the flow path 44 is gradually opened as the check ring 50 moves. As a result, the resin becomes able to flow toward the front side beyond the check sheet 48 along the flow path 44.

In the injection step described below, the pressure on the front side of the check ring 50 becomes greater than the pressure on the rear side of the check ring 50. When this occurs, the check ring 50 moves rearward relative to the screw 28, and the flow path 44 becomes gradually closed as the check ring 50 moves. When the check ring 50 is moved rearward until being seated on the check sheet 48, the resin becomes most unlikely to flow forward and rearward of the check ring 50, and the resin on the front side of the check sheet 48 is inhibited from flowing in reverse to the rear side of the check sheet 48.

The screw 28 is equipped with a pressure sensor 30. The pressure sensor 30 sequentially detects the pressure imposed on the resin inside the cylinder 26. As the pressure sensor 30, there may be used, for example, a load cell or the like, but is not limited to this. The pressure acting on the resin inside the cylinder 26 may also be referred to as a back pressure or a pressure of the resin (a resin pressure).

The first drive device 32 is configured to rotate the screw 28 inside the cylinder 26. The first drive device 32 includes a servomotor (motor) 52a. The first drive device 32 further includes a drive pulley 54a that rotates integrally with the rotary shaft of the servomotor 52a. The first drive device 32 further includes a driven pulley 56 that is integrated with the screw 28. The first drive device 32 further includes a belt member 58a that transmits a rotational force of the servomotor 52a from the drive pulley 54a to the driven pulley 56.

As the rotary shaft of the servomotor 52a rotates, the rotational force of the servomotor 52a is transmitted to the screw 28 via the drive pulley 54a, the belt member 58a, and the driven pulley 56. Thus, the screw 28 rotates.

In this manner, the first drive device 32 is configured to rotate the screw 28 by rotating the rotary shaft of the servomotor 52a. By changing the rotational direction of the rotary shaft of the servomotor 52a, the direction of rotation of the screw 28 can be switched between forward and reverse.

A sensor 60a is provided on the servomotor 52a. The sensor 60a can detect the rotational position and the rotational speed of the rotary shaft of the servomotor 52a. This sensor 60a may also be referred to as a position/speed sensor. The sensor 60a supplies a detection result to the control device 20. The control device 20 is configured to calculate the rotation amount (amount of rotation), the rotational acceleration, the rotational speed, etc. of the screw 28, based on the rotation position and the rotational speed detected by the sensor 60a.

The second drive device 34 is configured to move the screw 28 forward and rearward (backward). The second drive device 34 includes a servomotor (motor) 52b. A reference numeral 52 is used to describe the motors in general, and reference numerals 52a and 52b are used to describe individual motors. The second drive device 34 further includes a drive pulley 54b that rotates integrally with the rotary shaft of the servomotor 52b. The second drive device 34 further includes a ball screw 61. The axial line of the ball screw 61 and the axial line of the screw 28 coincide with each other on an imaginary line L. The second drive device 34 further includes a driven pulley 62 fixed to the ball screw 61. The second drive device 34 further includes a belt member 58b that transmits the rotational force of the servomotor 52b from the drive pulley 54b to the driven pulley 62. The second drive device 34 further includes a nut 63 that is screw-engaged with the ball screw 61.

When a rotational force is transmitted from the belt member 58b, the ball screw 61 converts the rotational force into linear motion and transmits the linear motion to the screw 28. As a result, the screw 28 moves forward and rearward.

In this way, the second drive device 34 is configured to move the screw 28 forward and rearward by rotating the rotary shaft of the servomotor 52b. By changing the rotational direction of the rotary shaft of the servomotor 52b, the moving direction of the screw 28 can be switched between forward (advancing) and rearward (retracting).

The servomotor 52b includes a sensor 60b. As the sensor 60b, there may be used the same sensor as the above-described sensor 60a, but is not limited to this. The control device 20 is configured to calculate a position of forward movement, a position of rearward movement, etc. of the screw 28 in the front-rear direction, based on the rotational position and the rotational speed detected by the sensor 60b. Further, the control device 20 is configured to calculate a forward movement speed, a rearward (backward) movement speed, etc. of the screw 28, based on the rotational position and the rotational speed detected by the sensor 60b.

As the screw 28 is forwardly rotated while the resin is introduced into the cylinder 26 through the hopper 36, the resin is gradually compressed and fed in the frontward direction along the flow path 44. At this time, the resin is melted (plasticized) by being subjected to heating by the heater 38 and the rotation of the screw 28. The molten resin accumulates in a region that is located at a position on the front side with respect to the check sheet 48 within the region inside the cylinder 26. The region on the front side with respect to the check sheet 48 within the cylinder 26 may be referred to as a metering region.

The forward rotation of the screw 28 is started from a state where the screw 28 has been completely advanced inside the cylinder 26 (a state in which the volume of the metering region is at a minimum), and is continued until the screw 28 is moved rearward to a predetermined position (the metering position). The rearward movement of the screw 28 is performed while the back pressure is kept at a predetermined value (metering pressure) P1. That is, the screw 28 is moved rearward while the servomotor 52b is feedback-controlled (back pressure controlled) based on the pressure detected by the pressure sensor 30, in a manner so that the back pressure applied to the resin becomes the metering pressure P1. This process may be referred to as a metering (metering step). In the metering step, as described above, the screw 28 is moved rearward to the predetermined metering position while being forwardly rotated, whereby metering of the resin in the cylinder 26 is performed while melting the resin.

Setting of the position of the screw 28 to the metering position by moving the screw 28 rearward while controlling the rearward movement of the screw 28 so as to maintain the back pressure during metering at the metering pressure P1, makes it possible to keep the volume of the metering region and the density of the resin substantially constant at each metering.

However, inertia is generated in the servomotor 52a that rotates the screw 28, the drive pulley 54a that transmits the rotational force of the servomotor 52a, the belt member 58a, and the driven pulley 56. Therefore, even if the rotation of the screw 28 is tried to be stopped, the rotation of the screw 28 cannot be stopped instantaneously due to the influence of the inertia. Therefore, a time lag occurs from when the screw 28 reaches the metering position until the forward rotation of the screw 28 comes to a stop. During such a time lag as well, the resin is continuously fed and compressed from the rearward direction toward the frontward direction. Further, even after the forward rotation of the screw 28 has been stopped, the flow of the resin from the rearward direction toward the frontward direction is not stopped instantaneously due to the influence of viscous resistance of the molten resin, and the resin continues to be fed and compressed for a while. Because of the above reasons, the amount of resin accumulated in the metering region actually tends to become greater than the amount (appropriate amount) of resin required for satisfactory molding. When the amount of the resin accumulated in the metering region is greater than the appropriate amount, the mass of the manufactured molded product may become uneven, which can be a primary cause of molding defects.

When the screw 28 reaches the metering position, the rotation of the screw 28 gradually slows down and the forward rotation of the screw 28 stops. After the forward rotation of the screw 28 is stopped, the reverse rotation of the screw 28 is started. The reason why the screw 28 is rotated in reverse is to reduce the back pressure. This step may be referred to as a reduction in pressure (pressure reducing step). At a time after completion of the pressure reducing step, it is preferable that the back pressure be brought in close proximity to zero (target pressure P0). In the pressure reducing step, as described above, the screw 28 is rotated in reverse on the basis of the predetermined reverse rotation conditions to thereby reduce the resin pressure (the pressure of the resin).

In the case that the reduction in pressure is excessive, air is drawn in from the nozzle 40 into the interior of the cylinder 26, and air bubbles become mixed in the resin inside the cylinder 26. Excessive reduction in pressure can occur, for example, in the case that the amount of pressure reduction during the reverse rotation of the screw 28 or the like is excessive. More specifically, excessive reduction in pressure may occur when the rotation amount of the screw 28 in the reverse direction is excessive. Excessive reduction in pressure can also occur when the vigorousness of the reduction in pressure is excessive. For example, when the rotational speed of the screw 28 is too high, excessive reduction in pressure may occur. When molding is performed using a resin with air bubbles mixed therein, an unevenness occurs in the mass of the molded product obtained by molding, which causes poor appearance, poor product quality, and other failures.

In the case that the pressure is not sufficiently reduced, a phenomenon called drooling, in which molten resin leaks from the tip of the nozzle 40, occurs. Therefore, it is ideal that the reduction in pressure is performed so as to inhibit air bubbles from being mixed into the resin accumulated in the cylinder 26 and also prevent drooling. After having carried out the metering step and the pressure reducing step, in order to fill the cavity inside the mold 12 with the resin that has accumulated in the metering region inside the cylinder 26, the screw 28 is advanced with the mold 12 and the nozzle 40 being pressed into contact (placed in a nozzle touching state). As a result, the molten resin is injected from the tip of the nozzle 40 into the mold 12. This series of processes may be referred to as injection (injection step). After having performed injection of the resin, a process referred to as mold opening (mold opening step) for opening the mold 12 is performed in the mold clamping unit 14, whereby the resin filled in the cavities is taken out from the mold 12 as a molded product. After having carried out the mold opening step, a process referred to as mold closing (mold closing step) for closing the mold 12 in the mold clamping unit 14 is performed in preparation for a subsequent molding.

In this manner, the metering step, the pressure reducing step, the injection step, the mold opening step, and the mold closing step are sequentially performed in the above-described order. Such a sequential process flow may be referred to as a molding cycle. The injection molding machine 10 can mass-produce molded products by repeatedly performing the molding cycle.

The control device 20 can execute at least the pressure reducing step among the multiple steps included in the molding cycle.

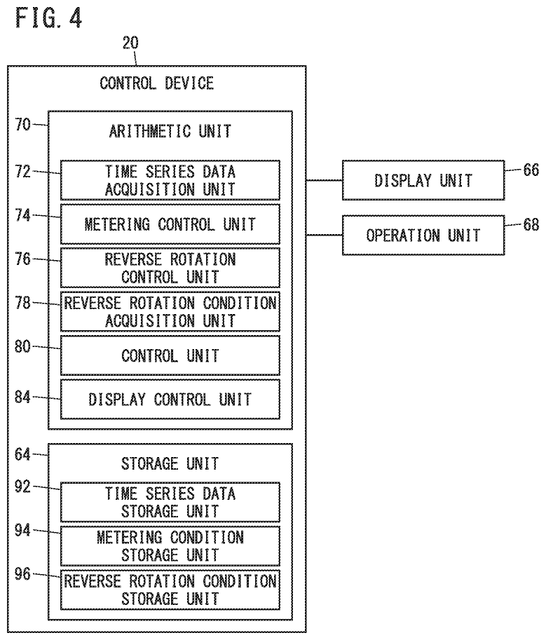

FIG. 4 is a block diagram showing a control device provided in the injection molding machine according to the present embodiment.

The control device 20 includes an arithmetic unit 70 and a storage unit 64. The arithmetic unit 70 can be configured of a processor such as a CPU, but is not limited to this. The storage unit 64 includes an unillustrated RAM, ROM and nonvolatile memory. Examples of the non-volatile memory include a flash memory and the like. Data and others can be temporarily stored in the RAM. Programs, tables, data and the like can be stored in the ROM, the non-volatile memory, and the like.

The arithmetic unit 70 includes a time series data acquisition unit 72, a metering control unit 74, a reverse rotation control unit 76, a reverse rotation condition acquisition unit 78, a control unit 80, and a display control unit 84. The time series data acquisition unit 72, the metering control unit 74, the reverse rotation control unit 76, the reverse rotation condition acquisition unit 78, the control unit 80, and the display control unit 84 can be realized by the arithmetic unit 70 running a program stored in the storage unit 64.

The storage unit 64 can previously store a predetermined control program for controlling the injection unit 16. In addition, various information can be stored as appropriate in the storage unit 64 when the control program is running. The storage unit 64 includes a time series data storage unit 92, a metering condition storage unit 94, and a reverse rotation condition storage unit 96.

A display unit (display device) 66 and an operation unit (input device) 68 can be connected to the control device 20.

The display unit 66 can be composed of, for example, a liquid crystal display or the like, but is not limited to this. Various pieces of information can be displayed on the display unit 66. For example, the reverse rotation conditions and others can be displayed on the display unit 66.

The operation unit 68 can include, for example, a keyboard, a mouse and the like, but is not limited to this. The operation unit 68 can be configured of an unillustrated touch panel (touch screen) provided on the screen of the display unit 66. The user can give a command to the injection molding machine 10 via the operation unit 68.

The metering control unit 74 performs the above-described metering based on the metering conditions. The forward rotational speed (metering rotational speed) of the screw 28 during metering, the metering pressure P1 and the like are specified as the metering conditions. The metering conditions are stored in advance in the metering condition storage unit 94. The metering conditions may be specified by the operator via the operation unit 68.

The metering control unit 74 moves the screw 28 rearward, while forwardly rotating the screw 28 until the screw 28 reaches the metering position. In this movement, the metering control unit 74 controls the first drive device 32, whereby the screw 28 is forwardly rotated at the metering rotational speed. Further, at this time, the metering control unit 74 controls the second drive device 34, whereby the rearward (backward) movement speed and the position of the screw 28 are controlled in a manner so that the back pressure becomes equal to the metering pressure P1. When the screw 28 reaches the metering position, the metering control unit 74 stops the forward rotation and the rearward movement of the screw 28, together with invoking operation of the reverse rotation control unit 76. As described above, there is a time lag from when the screw 28 reaches the metering position until when the forward rotation and the rearward movement of the screw 28 come to a stop.

After the forward rotation of the screw 28 has been stopped, the reverse rotation control unit 76 rotates the screw 28 in reverse based on the reverse rotation conditions. The reverse rotation conditions specify, as to the reverse rotation of the screw 28, at least one of an amount of rotation (angle of rotation) of the screw 28, a rotational acceleration of the screw 28, a rotational speed of the screw 28, and a rotation time of the screw 28 (i.e., a time for which the screw 28 rotates). The reverse rotation control unit 76 rotates the screw 28 in reverse based on the reverse rotation conditions stored in advance in the reverse rotation condition storage unit 96.

When the screw 28 is rotated in reverse, the resin on a more rearward side than the check sheet 48 is scraped out along the spiral flow path 44 from the check sheet 48 toward the hopper 36, i.e., in a direction opposite to that at the time of metering. As a result, the pressure of the resin on a more rearward side than the check sheet 48 decreases. Further, at a point in time when the reverse rotation of the screw 28 is started, the check ring 50 is located on the screw head 46 side, so that the flow path 44 is open. Accordingly, the resin accumulated in the metering region passes through the check ring 50 and moves from the front side to the rear side (backflow) as the reverse rotation of the screw 28 is continued. As a result, the pressure imposed on the resin in the metering region is alleviated and the back pressure is reduced. That is, by causing a reverse flow of the resin, the reverse rotation control unit 76 not only reduces the amount of resin accumulated in the metering region, but also reduces the back pressure. After the reverse rotation of the screw 28 has been performed in this manner, the reverse rotation control unit 76 causes the reverse rotation of the screw 28 to be stopped.

The time series data acquisition unit 72 can acquire a predetermined time series data set (time series data). The predetermined time series data set may include time series data on an electric current of the motor 52 that drives the injection molding machine 10. The predetermined time series data set may include time series data on a voltage applied to the motor 52. The predetermined time series data set may include time series data on a torque of the motor 52. The predetermined time series data set may include time series data on a rotation amount of the motor 52. The predetermined time series data set may include time series data on a rotational acceleration of the motor 52. The predetermined time series data set may include time series data on a rotational speed of the motor 52. The predetermined time series data set may include time series data on a rotation time of the motor 52. The predetermined time series data set may include time series data on a pressure of the resin (a resin pressure). The predetermined time series data set may include time series data on a temperature of the resin, and the predetermined time series data set may include time series data on a flow rate of the resin. The predetermined time series data set may include time series data on a flow velocity of the resin. Note that the predetermined time series data set does not need to include time series data on all of these. The predetermined time series data set may include time series data on at least one of these. The time series data acquisition unit 72 stores the acquired predetermined time series data set in the time series data storage unit 92. Here, a case where the time series data acquisition unit 72 acquires time series data on the pressure of the resin and time series data on the rotational speed of the servomotor 52a that rotates the screw 28 will be exemplified. Since the screw 28 is rotated by the servomotor 52a, the rotational speed of the screw 28 depends on the rotational speed of the servomotor 52a. The time series data acquisition unit 72 stores the time series data on the resin pressure acquired by the pressure sensor 30 and the time series data on the rotational speed of the servomotor 52a acquired by the sensor 60a in the time series data storage unit 92. The control unit 80 reads the predetermined time series data set acquired by the time series data acquisition unit 72 from the time series data storage unit 92. The control unit 80 supplies the predetermined time series data set read from the time series data storage unit 92 to the reverse rotation condition estimating apparatus 100 via the network 107.

The reverse rotation condition acquisition unit 78 acquires the reverse rotation conditions supplied from the reverse rotation condition estimating apparatus 100. Specifically, the reverse rotation condition estimating apparatus 100 estimates the reverse rotation conditions, based on the predetermined time series data set supplied to the reverse rotation condition estimating apparatus 100 from the control device 20 of the injection molding machine 10. Subsequently, the reverse rotation condition estimating apparatus 100 supplies the estimated reverse rotation conditions to the injection molding machine 10. In this way, the reverse rotation condition acquisition unit 78 acquires the reverse rotation conditions supplied from the reverse rotation condition estimating apparatus 100.

When the reverse rotation conditions acquired by the reverse rotation condition acquisition unit 78 are different from the reverse rotation conditions stored in the reverse rotation condition storage unit 96, the control unit 80 can perform the following process. That is, the control unit 80 updates the reverse rotation conditions stored in the reverse rotation condition storage unit 96 with the reverse rotation conditions acquired by the reverse rotation condition acquisition unit 78. After the reverse rotation conditions stored in the reverse rotation condition storage unit 96 are updated, the reverse rotation control unit 76 executes reverse rotation based on the updated reverse rotation conditions. That is, in the next injection molding, the reverse rotation control unit 76 executes reverse rotation based on the updated reverse rotation conditions. In this way, the control unit 80 stores the reverse rotation conditions estimated by the reverse rotation condition estimating apparatus 100 during the current injection molding, in the reverse rotation condition storage unit 96, as the reverse rotation conditions for the next injection molding.

FIG. 5 is a block diagram showing the reverse rotation condition estimating apparatus according to the present embodiment. FIG. 5 shows an example in which the reverse rotation condition estimating apparatus 100 according to the present embodiment operates in learning mode.

As shown in FIG. 5, the reverse rotation condition estimating apparatus 100 includes an acquisition unit 110. The acquisition unit 110 includes a data acquisition unit 130, an acquired data storage unit 150, a training data extraction unit 132, and a preprocessing unit 134. The data acquisition unit 130, the training data extraction unit 132, and the preprocessing unit 134 can be realized by a program stored in the storage unit 115 (see FIG. 1) being run in the arithmetic unit 111 (see FIG. 1). The acquired data storage unit 150 may be configured by the storage unit 115.

The data acquisition unit 130 can acquire data supplied from the injection molding machine 10 via the network 107. The data supplied from the injection molding machine 10 includes the predetermined time series data set described above. The data acquisition unit 130 stores the data supplied from the injection molding machine 10 in the acquired data storage unit 150.

The training data extraction unit 132 extracts a predetermined time series data set from the data stored in the acquired data storage unit 150. The training data extraction unit 132 extracts the predetermined time series data set supplied from the injection molding machine 10 at least during the pressure reducing step. The training data extraction unit 132 supplies the extracted predetermined time series data set to the preprocessing unit 134.

The preprocessing unit 134 performs a predetermined preprocessing on the predetermined time series data set extracted by the training data extraction unit 132. The preprocessing unit 134 supplies the preprocessed training data to the machine learning device 200.

The machine learning device 200 includes a learning unit 210 and a learning model storage unit 230. The learning unit 210 can be realized by a program stored in the storage unit 205 (see FIG. 1) being run in the arithmetic unit 201 (see FIG. 1). The learning model storage unit 230 may be configured by the storage unit 205.

The learning unit 210 generates or updates the learning model 235 by machine learning using the predetermined time series data set acquired by the acquisition unit 110. The learning model 235 is a learning model for estimating the reverse rotation conditions. The learning model 235 is configured to, when a predetermined time series data set is input, output a label corresponding to the predetermined time series data set. The learning unit 210 can generate or update the learning model 235 by, for example, supervised learning, but is not limited to this. Description herein will be given by giving an example where the learning model 235 is generated by supervised learning. The learning unit 210 generates a learning model 235 using an existing machine learning algorithm. As the machine learning algorithm, a multi-layer perceptron method, a recurrent neural network method, a long short-term memory method, a convolutional neural network method, and the like can be used. The learning model 235 can be generated as follows.

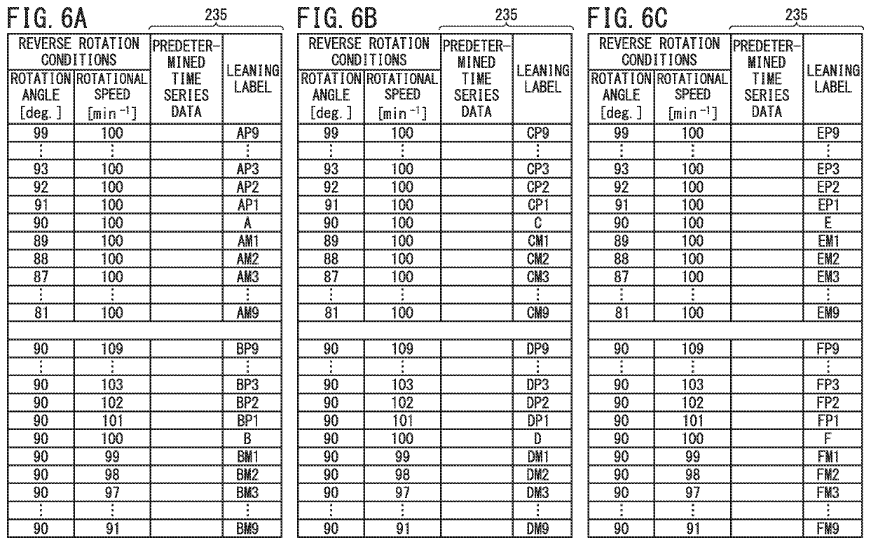

FIGS. 6A, 6B, and 6C are tables showing examples of reverse rotation conditions set when machine learning is performed. The description herein will be given by exemplifying a case where the reverse rotation conditions specify the rotation angle of the screw 28 and the rotational speed of the screw 28. The example shown herein is a case where the rough-target rotation angle by which the screw 28 should be rotated for satisfactory injection molding is 90 degrees, and the rough-target rotational speed at which the screw 28 should be rotated for satisfactory injection molding is 100 min⁻¹. FIG. 6A shows an example in which the target value of the pressure of the resin at the time of completion of the pressure reducing step is 0.0 MPa. FIG. 6B shows an example in which the target value of the pressure of the resin at the time of completion of the pressure reducing step is 0.1 MPa. FIG. 6C shows an example in which the target value of the pressure of the resin at the time of completion of the pressure reducing step is 0.2 MPa. The target value of the resin pressure at the time of completion of the pressure reducing step can be set at 0.3 MPa or higher as appropriate. However, in order to simplify the illustration, in the examples shown the target values of the resin pressure at the time of completion of the pressure reducing step are set at 0.0, 0.1 and 0.2 MPa.

When machine learning is performed, time series data sets are acquired by appropriately changing the reverse rotation conditions while appropriately changing the target value of the pressure of the resin at the completion of the pressure reducing step, and the acquired time series data sets are associated with respective labels.

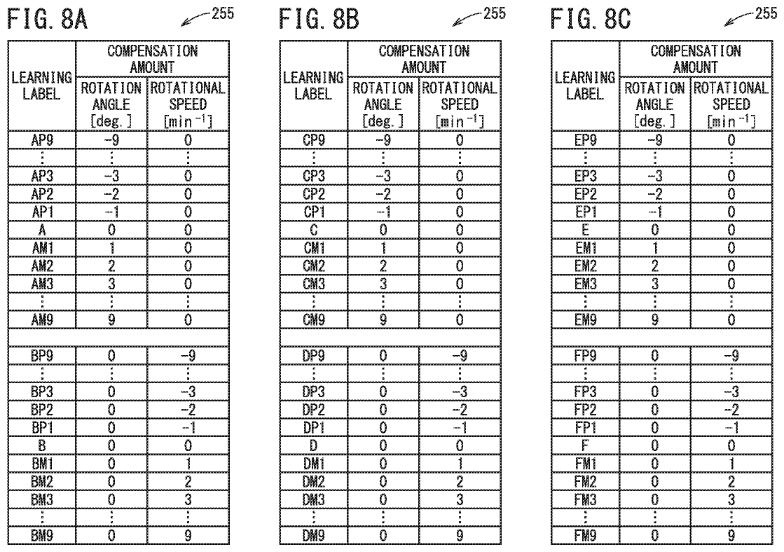

For example, as shown in FIG. 6A, first, the target value of the pressure of the resin at the completion of the pressure reducing step is set at 0.0 MPa. Then, the reverse rotation conditions in the injection molding machine 10 are set as follows, for example. That is, the rotation angle of the screw 28 is 90 degrees, and the rotational speed of the screw 28 is 100 min⁻¹. Then, with the reverse rotation conditions set in this way, the injection molding machine 10 performs injection molding a predetermined number of times. As a result, the predetermined number of the predetermined time series data sets are acquired. At least one time series data set to be associated with a label A is selected from among the predetermined number of the time series data sets thus obtained. The selection of the time series data set to be associated with the label A can be done by the user or the like through the operation unit 171, but is not limited to this. The time series data set to be associated with the label A is, for example, a time series data set in which the compensation amount of the rotation angle is 0 degrees and the compensation amount of the rotational speed is 0 min⁻¹. The relationship between the label A and the compensation amounts is shown in a table 255 (see FIG. 8A) described later. It is preferable that multiple time series data sets, among the predetermined number of the time series data sets thus obtained, be associated with the label A.

Next, the reverse rotation conditions in the injection molding machine 10 are changed, for example, as follows. That is, the rotation angle of the screw 28 is set at 91 degrees. The rotational speed of the screw 28 is kept as is, i.e., at 100 min⁻¹. Then, with the reverse rotation conditions thus set, the injection molding machine 10 performs injection molding a predetermined number of times. As a result, the predetermined number of the predetermined time series data sets are acquired. At least one time series data set to be associated with a label AP1 is determined, from among the predetermined number of the time series data sets thus obtained. The time series data set to be associated with the label AP1 is, for example, a time series data set in which the compensation amount of the rotation angle is −1 degree and the compensation amount of the rotational speed is 0 min⁻¹. The relationship between the label AP1 and the compensation amounts is shown in the table 255 (see FIG. 8A) described below. It is preferable that multiple time series data sets, among the predetermined number sets of the time series data thus obtained, be associated with the label AP1.

Thereafter, in the same manner as above, the rotation angle of the screw 28 is increased by 1 degree, and under the condition of the thus increased rotation angle, the predetermined time series data is acquired a predetermined number of times. Such a process is repeated. Then, in the same manner as above, acquired time series data sets are associated with labels AP2 to AP9, respectively.

Next, the reverse rotation conditions in the injection molding machine 10 are changed, for example, as follows. That is, the rotation angle of the screw 28 is set at 89 degrees. The rotational speed of the screw 28 is kept as is, i.e., at 100 min⁻¹. Then, the predetermined number of sets of the predetermined time series data are acquired. Similarly to the above, the time series data set is associated with a label AM1.

Thereafter, in the same manner as above, the rotation angle of the screw 28 is decreased by 1 degree, and under the condition of the thus decreased rotation angle, the predetermined time series data is acquired a predetermined number of times. Such a process is repeated. Then, in the same manner as above, acquired time series data sets are associated with labels AM2 to AM9, respectively.

Next, the reverse rotation conditions in the injection molding machine 10 are set, for example, as follows. That is, the rotation angle of the screw 28 is set at 90 degrees while the rotational speed of the screw 28 is set at 100 min⁻¹. Then, with the reverse rotation conditions thus set, the injection molding machine 10 performs injection molding a predetermined number of times. As a result, the predetermined number of sets of the predetermined time series data are acquired. From among the predetermined number of sets of the time series data thus obtained, at least one set of time series data is associated with a label B. It is preferable that multiple time series data sets, among the predetermined number of sets of time series data thus obtained, are associated with the label B.

Next, the reverse rotation conditions in the injection molding machine 10 are changed, for example, as follows. That is, the rotational speed of the screw 28 is set at 101 min⁻¹. The rotation angle of the screw 28 is kept at 90 degrees. Then, with the reverse rotation conditions thus set, the injection molding machine 10 performs injection molding a predetermined number of times. As a result, the predetermined number of sets of the predetermined time series data are acquired. From among the predetermined number of sets of the time series data thus obtained, at least one time series data set is associated with a label BP1. It is preferable that multiple time series data sets, among the predetermined number of sets of time series data thus obtained, are associated with the label BP1.

Thereafter, in the same manner as above, the rotational speed of the screw 28 is increased by 1 min⁻¹, and under the condition of the thus increased rotational speed, the predetermined time series data is acquired a predetermined number of times. Such a process is repeated. Then, in the same manner as above, the acquired time series data sets are associated with labels BP2 to BP9, respectively.

Next, the reverse rotation conditions in the injection molding machine 10 are changed, for example, as follows. That is, the rotational speed of the screw 28 is set at 99 min⁻¹. The rotation angle of the screw 28 is kept at 90 degrees. Then, the predetermined number of sets of the predetermined time series data are acquired. Similarly to the above, the time series data set is associated with a label BM1.

Thereafter, in the same manner as above, the rotational speed of the screw 28 is decreased by 1 min⁻¹, and under the condition of the thus decreased rotational speed, the predetermined time series data is acquired a predetermined number of times. Such a process is repeated. Then, in the same manner as above, the acquired time series data sets are associated with labels BM2 to BM9, respectively.

Thereafter, as shown in FIG. 6B, the target value of the pressure of the resin at the completion of the pressure reducing step is set at 0.1 MPa, and the reverse rotation conditions are changed in the same manner as above. Then the time series data sets acquired in the same manner as above are associated with labels CP9 to CM9 and DP9 to DM9, respectively.

After that, as shown in FIG. 6C, the target value of the pressure of the resin at the completion of the pressure reducing step is set at 0.2 MPa, and the reverse rotation conditions are changed in the same manner as above, and the time series data sets acquired in the same manner as above are associated with labels EP9 to EM9 and FP9 to FM9, respectively.

Furthermore, the target value of the pressure of the resin at the completion of the pressure reducing step is further changed appropriately, and the reverse rotation conditions are appropriately changed as described above, and the time series data sets obtained in the same manner as above are associated with labels.

In this way, the learning model 235 is generated by associating the predetermined time series data sets with the labels. When a predetermined time series data set is input, the learning model 235 can output a label corresponding to the predetermined time series data set. The learning unit 210 can also update the learning model 235 thus generated, in the same manner as described above.

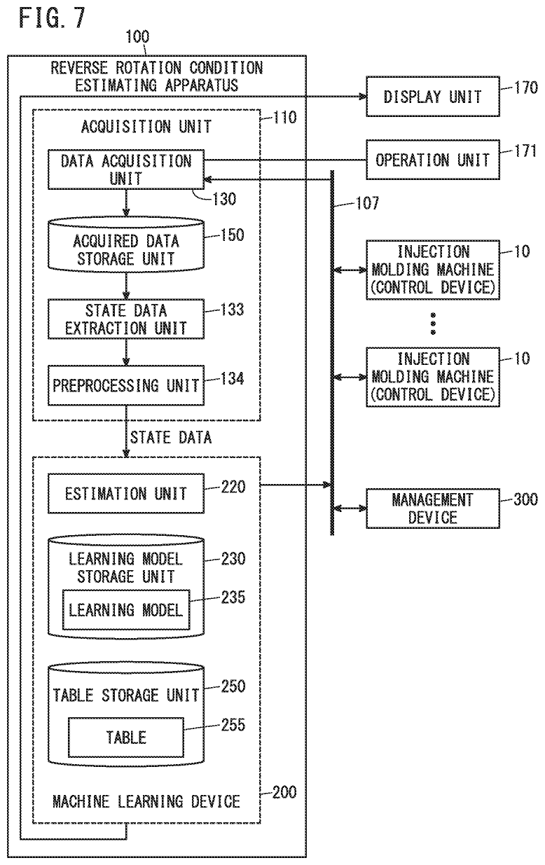

FIG. 7 is a block diagram showing the reverse rotation condition estimating apparatus according to the present embodiment. FIG. 7 shows an example in which the reverse rotation condition estimating apparatus 100 according to the present embodiment operates in the estimation mode.

As shown in FIG. 7, the reverse rotation condition estimating apparatus 100 includes an acquisition unit 110, like the reverse rotation condition estimating apparatus 100 described above with reference to FIG. 5. The acquisition unit 110 includes a data acquisition unit 130, an acquired data storage unit 150, a state data extraction unit 133, and a preprocessing unit 134. The data acquisition unit 130, the state data extraction unit 133, and the preprocessing unit 134 are realized by a program stored in the storage unit 115 (see FIG. 1) being run by the arithmetic unit 111 (see FIG. 1). The acquired data storage unit 150 can be configured by the storage unit 115.

The data acquisition unit 130 can acquire data supplied from the injection molding machine 10 via the network 107. The data supplied from the injection molding machine 10 includes the predetermined time series data (data sets) described above. The data acquisition unit 130 stores the data supplied from the injection molding machine 10 in the acquired data storage unit 150.

The state data extraction unit 133 extracts a predetermined time series data set from the data stored in the acquired data storage unit 150. The state data extraction unit 133 extracts a predetermined time series data set supplied from the injection molding machine 10 at least during the pressure reducing step. The state data extraction unit 133 supplies the extracted predetermined time series data set to the preprocessing unit 134.

The preprocessing unit 134 performs a predetermined preprocessing on the predetermined time series data set extracted by the state data extraction unit 133. The preprocessing unit 134 supplies the preprocessed state data to the machine learning device 200.

The machine learning device 200 includes a learning model storage unit 230, a table storage unit 250, and an estimation unit 220. The estimation unit 220 can be realized by a program stored in the storage unit 205 (see FIG. 1) being run by the arithmetic unit 201 (see FIG. 1). The learning model storage unit 230 and the table storage unit 250 can be configured by the storage unit 205.

The learning model storage unit 230 stores the learning model 235 generated or updated by the learning unit 210.

The table storage unit 250 stores the table 255. The estimation unit 220 can refer to the table 255. FIGS. 8A, 8B, and 8C are diagrams showing table examples. The tables 255 show the compensation amounts corresponding to the respective labels. FIG. 8A shows the table 255 used when the target value of the pressure of the resin at the completion of the pressure reducing step is 0.0 MPa. FIG. 8B shows the table 255 used when the target value of the pressure of the resin at the completion of the pressure reducing step is 0.1 MPa. FIG. 8C shows the table 255 used when the target value of the resin pressure at the completion of the pressure reducing step is 0.2 MPa. Here, for simplification, examples of the table 255 used when the target value of the pressure of the resin at the completion of the pressure reducing step are set at 0.0, 0.1 and 0.2 MPa, are shown. The table 255 for cases where the target value of the resin pressure at the completion of the pressure reducing step is set at 0.3 MPa or more, may be further stored in the table storage unit 250.

The estimation unit 220 can estimate the reverse rotation conditions based on the learning model 235 and the table 255. More specifically, the estimation unit 220 inputs the state data supplied from the acquisition unit 110, that is, the predetermined time series data set, to the learning model 235. As the predetermined time series data set is input to the learning model 235, a label corresponding to the predetermined time series data set is output from the learning model 235. The estimation unit 220 acquires the compensation amount according to the label output from the learning model 235, based on the table 255. As described later, when a predetermined time series data set is supplied from an injection molding machine 10 to the reverse rotation condition estimating apparatus 100, the reverse rotation conditions at the time when the time series data set has been acquired is also supplied from the injection molding machine 10 to the reverse rotation condition estimating apparatus 100. The estimation unit 220 compensates the reverse rotation conditions supplied from the injection molding machine 10 with the compensation amounts acquired as described above. The reverse rotation conditions obtained by such compensation are set as reverse rotation conditions for the subsequent injection molding in the injection molding machine 10. Thus, estimation of the reverse rotation conditions can be performed by the estimation unit 220. In this way, the estimation unit 220 can estimate the reverse rotation conditions using the predetermined time series data set acquired by the acquisition unit 110 and the learning model 235 stored in the learning model storage unit 230.

The machine learning device 200 supplies the reverse rotation conditions estimated by the estimation unit 220 to the injection molding machine 10 via the network 107. The reverse rotation conditions thus supplied to the injection molding machine 10 are set as the reverse rotation conditions for the next injection molding of the injection molding machine 10 as described above.

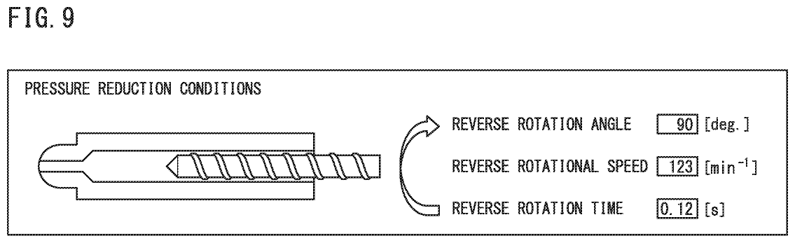

The display control unit 117 (see FIG. 1) can display various pieces of information on the display unit 170. For example, the display control unit 117 can cause the display unit 170 to display the reverse rotation conditions estimated by the machine learning device 200. FIG. 9 is a diagram showing an example of display on the display unit. FIG. 9 shows an example in which the estimated reverse rotation conditions are displayed on the display unit 170. As shown in FIG. 9, for example, the reverse rotation angle, that is, the rotation amount by which the screw 28 is rotated in reverse, can be displayed on the display unit 170. Additionally, for example, the reverse rotational speed, that is, the rotational speed at which the screw 28 is rotated in reverse, can be displayed on the display unit 170. Further, for example, the reverse rotation time, that is, a time for which the screw 28 is rotated in reverse, can be displayed on the display unit 170.

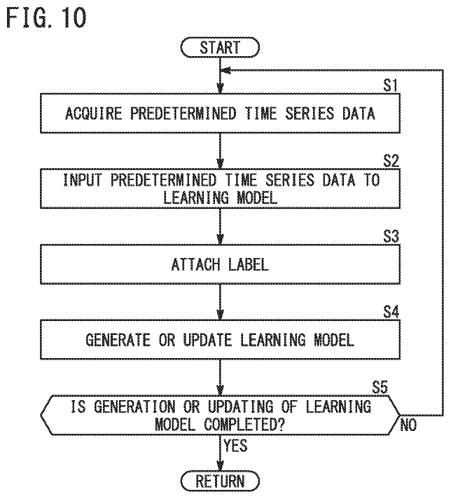

Referring to FIG. 10, an operation example of the reverse rotation condition estimating apparatus according to this embodiment will be described. FIG. 10 is a flowchart showing an example of the operation of the reverse rotation condition estimating apparatus according to the present embodiment. This example in FIG. 10 shows the operation in learning mode.

At step S1, the acquisition unit 110 acquires the predetermined time series data supplied from the injection molding machine 10, a predetermined number of times. The thus obtained predetermined number of sets of the time series data, that is, the predetermined number of sets of training data, are supplied to the machine learning device 200. The display control unit 117 displays on the display unit 170 the predetermined number of sets of the predetermined time series data supplied from the injection molding machine 10 to the machine learning device 200. After this, the control proceeds to step S2.

At step S2, the learning unit 210 inputs the predetermined time series data set (data) supplied from the acquisition unit 110, to the learning model 235. After this, the control proceeds to step S3.

At step S3, a label is attached (assigned) to the predetermined time series data set. At least one set of time series data to be associated with a predetermined label is selected from the predetermined number of sets of times series data. The selection of the time series data set to be associated with the label can be done by the user or the like through the operation unit 171, but the selection is not limited to this. In this way, the label is associated with the predetermined time series data set. After this, the control proceeds to step S4.

At step S4, the learning unit 210 generates or updates the learning model 235. As described above, when a predetermined time series data set is input, the learning model 235 can output a label corresponding to the predetermined time series data set. After this, the control proceeds to step S5.

At step S5, the learning unit 210 determines whether or not generation or updating of the learning model has been completed. When neither generation nor updating of the learning model has been completed (NO at step S5), the control from step S1 is repeated. When generation or updating of the learning model is completed (YES at step S5), the control shown in FIG. 10 is ended.

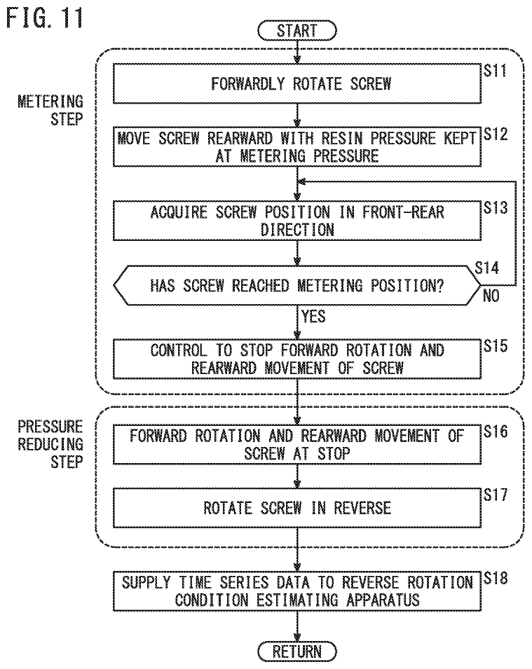

Referring next to FIG. 11, an operational example of the injection molding machine according to this embodiment will be described. FIG. 11 is a flowchart showing an operational example of the injection molding machine according to this embodiment. Steps S11 to S15 constitute the metering step. Steps S16 to S17 constitute the pressure reducing step. Description herein will be given by exemplifying a case where the time series data acquisition unit 72 acquires the time series data of the pressure reducing step.

At step S11, the metering control unit 74 causes the screw 28 to rotate forwardly based on the metering condition. The metering condition can be read from the metering condition storage unit 94. Then, the control proceeds to step S12.

At step S12, the metering control unit 74 moves the screw 28 rearward while keeping the resin pressure at the metering pressure P1. Then, the control proceeds to step S13.

At step S13, the metering control unit 74 acquires the position of the screw 28 in the front-rear direction. After this, the control proceeds to step S14.

At step S14, it is determined whether or not the screw 28 reaches the metering position. When the screw 28 reaches the metering position (YES at step S14), the control proceeds to step S15. If the screw 28 has not reached the metering position (NO at step S14), steps S13 and S14 are repeated.

At step S15, the metering control unit 74 provides control so as to stop the forward rotation and the rearward movement of the screw 28. As described above, even if an attempt to stop the forward rotation of the screw 28 is made, the screw 28 cannot be stopped instantly due to the influence of inertia. Therefore, there occurs a time lag from the start of the control by the metering control unit 74 to stop the forward rotation and the rearward movement of the screw 28 until the forward rotation and the rearward movement of the screw 28 actually stop. When the screw 28 reaches the metering position, the time series data acquisition unit 72 starts acquisition of the time series data (data set). Note that, description herein will be given concerning a case where the acquisition of the time series data is started when the screw 28 reaches the metering position, but acquisition of the time series data may be started before the screw 28 reaches the metering position. The time series data acquisition unit 72 sequentially stores the acquired time series data in the time series data storage unit 92. After this, the control proceeds to step S16.

At step S16, the forward rotation and the rearward movement of the screw 28 stop. Then, the control proceeds to step S17.

At step S17, the reverse rotation control unit 76 rotates the screw 28 in reverse based on the reverse rotation conditions. The reverse rotation conditions can be read from the reverse rotation condition storage unit 96. After that, the control goes to step S18.

At step S18, the control unit 80 reads the time series data stored in the time series data storage unit 92 from the time series data storage unit 92. Then, the control unit 80 supplies the read time series data to the reverse rotation condition estimating apparatus 100 via the network 107. When supplying the predetermined time series data to the reverse rotation condition estimating apparatus 100, the control unit 80 also supplies the following information to the reverse rotation condition estimating apparatus 100. That is, the control unit 80 further supplies the ID for identifying the injection molding machine 10 to the reverse rotation condition estimating apparatus 100. Further, the control unit 80 further supplies the reverse rotation condition estimating apparatus 100 the reverse rotation conditions at the time when the time series data has been acquired. Thus, the control shown in FIG. 11 is completed.

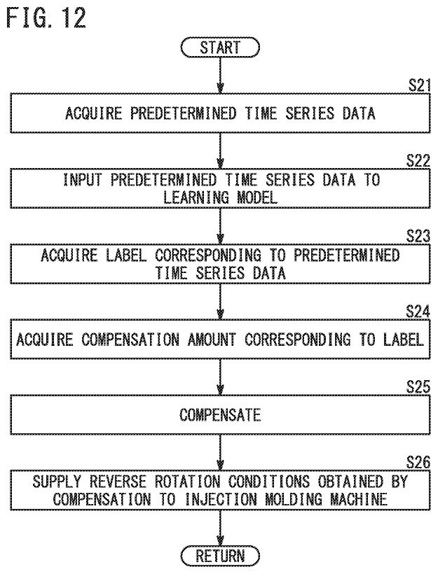

Referring next to FIG. 12, an operation example of the reverse rotation condition estimating apparatus according to this embodiment will be described. FIG. 12 is a flowchart showing an operation example of the reverse rotation condition estimating apparatus according to the present embodiment. FIG. 12 shows an example of operation in estimation mode.

At step S21, the acquisition unit 110 acquires a predetermined time series data set (data) supplied from the injection molding machine 10. The predetermined time series data set thus obtained, that is, the state data, is supplied to the machine learning device 200. Then, the control proceeds to step S22.

At step S22, the estimation unit 220 inputs the predetermined time series data set (data) supplied from the acquisition unit 110, to the learning model 235. Then, the control goes to Step S23.

At step S23, the estimation unit 220 acquires a label output from the learning model 235 according to predetermined time series data set (data). Then, the control goes to Step S24.

At step S24, the estimation unit 220 acquires the compensation amounts according to the label output from the learning model 235, based on the table 255. Then, the control goes to Step S25.

At step S25, the estimation unit 220 compensates the reverse rotation conditions supplied from the injection molding machine 10 together with the predetermined time series data set (data), that is, the reverse rotation conditions at the current injection molding, with the compensation amounts as acquired as described above. That is, the estimation unit 220 estimates the reverse rotation conditions. Then, the control goes to Step S26.

At step S26, the estimation unit 220 supplies the reverse rotation conditions obtained by this compensation to the injection molding machine 10 via the network 107. As described above, the injection molding machine 10 supplies the predetermined time series data set (data) together with the ID for identifying the injection molding machine 10, to the reverse rotation condition estimating apparatus 100. Therefore, the reverse rotation conditions estimated by the reverse rotation condition estimating apparatus 100 is supplied via the network 107 to the injection molding machine 10 that has supplied the predetermined time series data set to the reverse rotation condition estimating apparatus 100. That is, the reverse rotation conditions estimated by the reverse rotation condition estimating apparatus 100 are supplied via the network 107 to the injection molding machine 10 whose ID coincides with the ID that was supplied together with the predetermined time series data set. Thus, the control shown in FIG. 12 is completed.

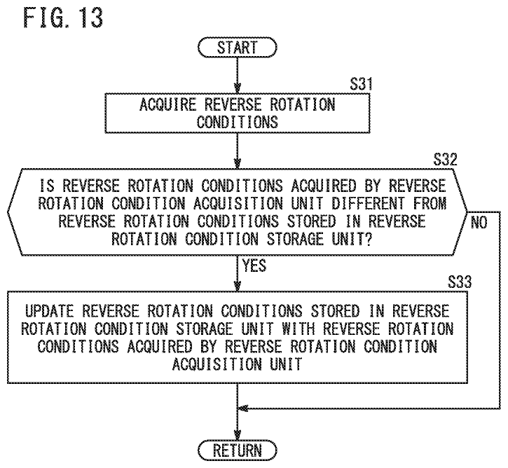

Referring to FIG. 13, an operation example of the injection molding machine according to this embodiment will be described. FIG. 13 is a flowchart showing an operation example of the injection molding machine according to the present embodiment. FIG. 13 shows an example of an operation after the reverse rotation conditions estimated by the reverse rotation condition estimating apparatus 100 are supplied from the reverse rotation condition estimating apparatus 100 to the injection molding machine 10.

At step S31, the reverse rotation condition acquisition unit 78 acquires the reverse rotation conditions supplied from the reverse rotation condition estimating apparatus 100 via the network 107. Then, the control goes to Step S32.

At step S32, the control unit 80 determines whether the reverse rotation conditions acquired by the reverse rotation condition acquisition unit 78 are different from the reverse rotation conditions stored in the reverse rotation condition storage unit 96. When the reverse rotation conditions acquired by the reverse rotation condition acquisition unit 78 are different from the reverse rotation conditions stored in the reverse rotation condition storage unit 96 (YES at step S32), the control proceeds to step S33. When the reverse rotation conditions acquired by the reverse rotation condition acquisition unit 78 and the reverse rotation conditions stored in the reverse rotation condition storage unit 96 are not different (NO at step S32), the control shown in FIG. 13 is ended.

At step S33, the control unit 80 updates the reverse rotation conditions stored in the reverse rotation condition storage unit 96 with the reverse rotation conditions acquired by the reverse rotation condition acquisition unit 78. That is, the control unit 80 stores the reverse rotation conditions estimated by the reverse rotation condition estimating apparatus 100 at the time of the current injection molding, in the reverse rotation condition storage unit 96 as the reverse rotation conditions for the next injection molding. Thus, the control shown in FIG. 13 is completed.

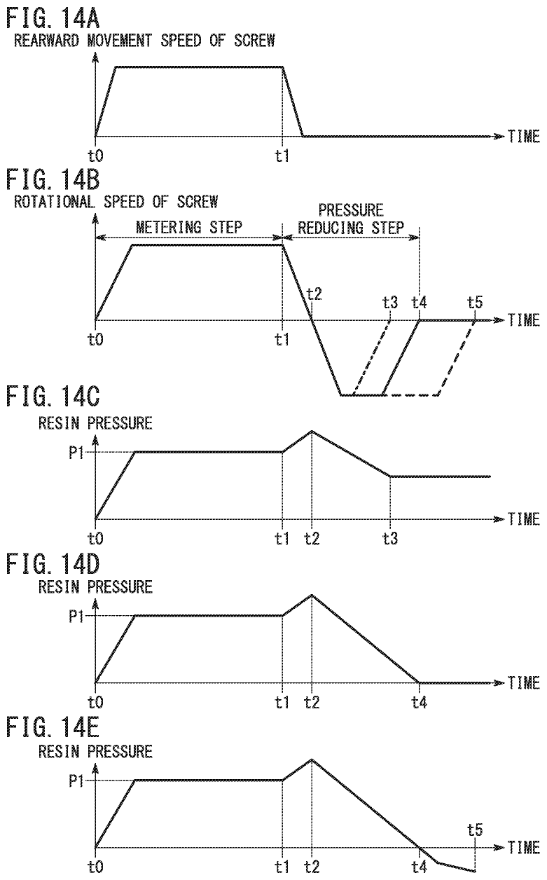

FIGS. 14A, 14B, 14C, 14D, and 14E are timing charts showing an operation example of the injection molding machine according to the present embodiment. FIG. 14A exemplifies the rearward movement speed of the screw 28. FIG. 14B exemplifies the rotational speed of the screw 28. FIGS. 14C, 14D, and 14E show resin pressure (pressure of resin). FIG. 14C shows an example in which reverse rotation is insufficient. FIG. 14D shows an example in which reverse rotation is performed properly. FIG. 14E shows an example where reverse rotation is performed excessively. The horizontal axis in FIGS. 14A to 14E represents time. The vertical axis in FIG. 14A represents the rearward movement speed of the screw 28. The vertical axis in FIG. 14B represents the rotational speed of the screw 28. The vertical axes in FIGS. 14C to 14E represent the pressure of the resin.

Time t0 indicates a time at which the metering step is started. As shown in FIG. 14A, the rearward movement speed of the screw 28 starts to rise at time to. Then, as shown in FIG. 14B, the rotational speed of the screw 28 starts to rise at time t0. Further, as shown in FIGS. 14C to 14E, the resin pressure starts to rise at time t0. Thereafter, as shown in FIG. 14B, the rotational speed of the screw 28 reaches the metering rotational speed specified by the metering conditions. Further, as shown in FIGS. 14C to 14E, the pressure of the resin reaches the metering pressure P1 specified by the metering conditions. The rearward movement speed of the screw 28 is controlled in a manner so that the resin pressure is maintained at the metering pressure P1.

Time t1 indicates a time at which the screw 28 reaches the metering position. The period from time t0 to time t1 corresponds to the metering step

As shown in FIG. 14A, after time t1, the rearward movement speed of the screw 28 rapidly decreases, and eventually the rearward movement speed of the screw 28 becomes zero. Further, as shown in FIG. 14B, after time t1, the rotational speed of the screw 28 rapidly decreases, and eventually the rotational speed of the screw 28 becomes zero. Time t2 is a time at which the rotational speed of the screw 28 becomes zero. During the period from time t1 to time t2, the resin pressure rises, as shown in FIGS. 14C to 14E. The reason why the resin pressure rises in this way during the period from time t1 to time t2 is that the resin is continuously fed and compressed. Therefore, an amount of the resin in excess of an appropriate amount is accumulated in a location on the front side (metering region) with respect to the check sheet 48.

As shown in FIG. 14B, the reverse rotation of the screw 28 is started at time t2. Therefore, as shown in FIGS. 14C to 14E, after time t2, the resin pressure gradually decreases. When the screw 28 rotates in reverse, a reverse flow of the resin occurs inside the cylinder 26, and the amount of resin in the metering region approaches the appropriate amount. Thus, the pressure reducing step is performed.

As shown by the one-dot-dashed line in FIG. 14B, in the case that the reverse rotation of the screw 28 is stopped at a relatively early time t3, then as shown in FIG. 14C, the resin pressure becomes excessively high at the time when the reverse rotation of the screw 28 is stopped.

As shown by the solid line in FIG. 14B, in the case that the reverse rotation of the screw 28 is stopped at an appropriate time t4, then as shown in FIG. 14D, the resin pressure at the time when the reverse rotation of the screw 28 is stopped becomes appropriate.

As shown by the broken line in FIG. 14B, in the case that the reverse rotation of the screw 28 is stopped at a relatively late time t5, then as shown in FIG. 14E, the resin pressure becomes excessively low at the time when the reverse rotation of the screw 28 is stopped.

When time series data (data set) as shown in FIG. 14C is input to the learning model 235, the learning model 235 can output, for example, the label AM9 or the label BM9. When the label AM9 is output from the learning model 235, the compensation amount of the rotation angle corresponding to the label AM9 is 9 degrees as is apparent from the table 255. When the label BM9 is output from the learning model 235, the compensation amount of the rotational speed corresponding to the label BM9 is 9 min′ as is apparent from the table 255. When the time series data as shown in FIG. 14C is input to the learning model 235, the reverse rotation conditions can be compensated by the compensation amount thus obtained.

When time series data (data set) as shown in FIG. 14D is input to the learning model 235, the learning model 235 can output, for example, the label A or the label B. When the label A is output from the learning model 235, the compensation amount of the rotation angle corresponding to the label A is 0 degree and the compensation amount of the rotational speed corresponding to the label A is 0 min⁻¹, as is apparent from the table 255. When the label B is output from the learning model 235, the compensation amount of the rotation angle corresponding to the label B is 0 degree, and the compensation amount of the rotational speed corresponding to the label B is 0 min⁻¹ as is apparent from the table 255. Therefore, when the time series data as shown in FIG. 14D is input to the learning model 235, no compensation for the reverse rotation conditions is needed.

When time series data (data set) as shown in FIG. 14E is input to the learning model 235, the learning model 235 can output, for example, the label AP9 or the label BP9. When the label AP9 is output from the learning model 235, the compensation amount of the rotation angle corresponding to the label AP9 is −9 degrees as is apparent from the table 255. When the label BP9 is output from the learning model 235, the rotational speed compensation amount corresponding to the label BP9 is −9 min⁻¹ as is apparent from the table 255. The thus obtained compensation amounts are used to compensate the reverse rotation conditions. When the time series data as shown in FIG. 14E is input to the learning model 235, the reverse rotation conditions can be compensated by the compensation amounts thus obtained.

As described heretofore, according to the present embodiment, at least the predetermined time series data (data set) supplied from the injection molding machine 10 during the pressure reducing step and the learning model 235 stored in the learning model storage unit 230 are used to estimate the reverse rotation conditions. Therefore, according to the present embodiment, it is possible to provide a reverse rotation condition estimating apparatus 100 that can favorably estimate the reverse rotation conditions of the screw 28 of the injection molding machine 10. Thus, according to this embodiment, the screw 28 can be rotated in reverse under appropriate reverse rotation conditions, thus making it possible to produce satisfactory molded products.

Although the preferred embodiment of the present invention has been described above, the present invention is not limited to the above embodiment, and various modifications can be made without departing from the scope of the invention.

For example, the above embodiment is implemented based on supervised learning, but the present invention is not limited to this. For example, unsupervised learning may be used. In the case of unsupervised learning, in the learning mode, injection molding is repeatedly implemented under appropriate reverse rotation condition to thereby generate a learning model at normal time. In the estimation mode, the reverse rotation conditions are calculated according to the score of the estimation result, using a conversion table, a conversion function, or the like prepared in advance. The conversion table and the conversion function can convert the score into the reverse rotation conditions. As an unsupervised learning algorithm, the autoencoder method, the k-means method, or the like can be used.

Further, the above embodiment is implemented based on supervised learning, but the present invention may be implemented based on reinforcement learning. Reinforcement learning is performed as follows, for example. The ideal pressure of the resin when the rotational speed of the screw 28 becomes zero shall be the first pressure. A set of time series data is acquired by performing injection molding under reverse rotation conditions obtained by modifying the appropriate reverse rotation conditions by predetermined amounts. Based on the thus obtained time series data set, the pressure of the resin when the rotational speed of the screw 28 becomes zero, i.e., the second pressure, is acquired. In reinforcement learning, a difference obtained by subtracting the second pressure from the first pressure is assigned as a reward (penalty) to thereby perform learning. Examples of the algorithm for reinforcement learning include Q-learning.

Further, in the above embodiment, an example has been described in which the injection molding machine 10 is an in-line injection molding machine. However, the present invention is not limited to this. For example, the injection molding machine 10 may be a preplasticating type injection molding machine (screw preplasticating type injection molding machine).

In the above embodiment, an example has been described in which the first drive device 32 includes the servomotor 52a and the second drive device 34 includes the servomotor 52b. However, the present invention is not limited to this. For example, the first drive device 32 may be equipped with a hydraulic cylinder, a hydraulic motor and the like. Further, the second drive device 34 may also be equipped with a hydraulic cylinder, a hydraulic motor and the like.

The above embodiment can be summarized as follows:

A reverse rotation condition estimating apparatus (100) for estimating reverse rotation conditions of an injection molding machine (10), the injection molding machine including a cylinder (26) into which a resin is supplied and a screw (28) configured to move forward and rearward and rotate inside the cylinder, the injection molding machine being configured to perform at least a metering step of performing metering of the resin while the resin is being melted inside the cylinder, by causing the screw to be moved rearward to a predetermined metering position while being forwardly rotated and a pressure reducing step of reducing a pressure of the resin by rotating the screw in reverse based on the reverse rotation conditions that are predetermined, includes: a learning model storage unit (230) configured to store a learning model (235) configured to estimate the reverse rotation conditions; an acquisition unit (110) configured to acquire a predetermined time series data set (predetermined time series data) supplied from the injection molding machine at least during the pressure reducing step; and an estimation unit (220) configured to estimate the reverse rotation conditions using the predetermined time series data set acquired by the acquisition unit and the learning model stored in the learning model storage unit. In this configuration, the reverse rotation conditions of the screw of the injection molding machine are estimated based on the predetermined time series data supplied from the injection molding machine during at least the pressure reducing step and the learning model stored in the learning model storage unit. Accordingly, this configuration enables favorable estimation of the reverse rotation conditions of the screw of the injection molding machine. Therefore, this configuration makes it possible to perform reverse rotation of the screw under appropriate reverse rotation conditions, and hence it is possible to obtain satisfactory molded articles.

The reverse rotation condition estimating apparatus may further include a learning unit (210) configured to generate or update the learning model by machine learning using the predetermined time series data set acquired by the acquisition unit. This configuration can generate or update the learning model.

The learning unit may be configured to generate or update the learning model on the basis of at least one of supervised learning, unsupervised learning, and reinforcement learning.

The learning unit may be configured to generate the learning model by the supervised learning; the learning model may be a learning model configured to output a label corresponding to the predetermined time series data set acquired by the acquisition unit; the reverse rotation condition estimating apparatus may further include a table storage unit (250) configured to store a table (255) indicating the relationship between the labels and the reverse rotation conditions; and the estimation unit may be configured to acquire the reverse rotation conditions associated with the label corresponding to the predetermined time series data set acquired by the acquisition unit, based on the table.

The reverse rotation conditions may specify at least one of a rotation amount of the screw, a rotational acceleration of the screw, a rotational speed of the screw, and a rotation time of the screw.

The reverse rotation condition estimating apparatus may further include a display control unit (117) configured to display on a display unit (170) the reverse rotation conditions estimated by the estimation unit. This configuration enables the user to easily grasp the estimated reverse rotation conditions.

The injection molding machine may further include a reverse rotation condition storage unit (96) configured to store, in the reverse rotation condition storage unit, the reverse rotation conditions, and a control unit (80) configured to store the reverse rotation conditions estimated by the estimation unit during the current injection molding, as the reverse rotation conditions for the next injection molding.

The time series data set may include a time series data set on at least one of an electric current of a motor (52a, 52b) configured to drive the injection molding machine, a voltage applied to the motor, a torque of the motor, a rotation amount of the motor, a rotational acceleration of the motor, a rotation speed of the motor, a rotation time of the motor, a pressure of the resin, a temperature of the resin, a flow rate of the resin, and a flow velocity of the resin.

The acquisition unit may be configured to acquire the predetermined time series data set supplied from at least one of a plurality of the injection molding machines connected by a network (107).

An injection molding machine is equipped with the reverse rotation condition estimating apparatus described above.

There is provided a reverse rotation condition estimating method of estimating reverse rotation conditions of an injection molding machine. The injection molding machine includes a cylinder into which a resin is supplied and a screw configured to move forward and rearward and rotate inside the cylinder. The injection molding machine is configured to perform at least a metering step of performing metering of the resin while the resin is being melted inside the cylinder, by causing the screw to be moved rearward to a predetermined metering position while being forwardly rotated and a pressure reducing step of reducing a pressure of the resin by rotating the screw in reverse based on the reverse rotation conditions that are predetermined. The method includes an acquisition step (S21) of acquiring a predetermined time series data set (a predetermined time series data) supplied from the injection molding machine at least during the pressure reducing step; and a step (S25) of estimating the reverse rotation conditions using the predetermined time series data set acquired at the acquisition step and a learning model configured to estimate the reverse rotation conditions.

The reverse rotation condition estimating method may further include a step (S4) of generating or updating the learning model by machine learning using the predetermined time series data set acquired at the acquisition step.

The step of generating or updating the learning model may generate or update the learning model on the basis of at least one of supervised learning, unsupervised learning, and reinforcement learning.

The step of generating or updating the learning model may generate the learning model by the supervised learning; the learning model may be a learning model configured to output a label corresponding to the predetermined time series data set acquired at the acquisition step; and the step of estimating the reverse rotation conditions may acquire the reverse rotation conditions associated with the label corresponding to the predetermined time series data set acquired at the acquisition step, based on a table that indicates the relationship between the labels and the reverse rotation conditions.

The reverse rotation condition estimating method may further include a step (S33) of storing, in a reverse rotation condition storage unit, the reverse rotation conditions estimated during the current injection molding, as the reverse rotation conditions for the next injection molding.

What is claimed is:

1. A reverse rotation condition estimating apparatus for estimating reverse rotation conditions of an injection molding machine, the injection molding machine including a cylinder into which a resin is supplied and a screw configured to move forward and rearward and rotate inside the cylinder, the injection molding machine being configured to perform at least a metering step of performing metering of the resin while the resin is being melted inside the cylinder, by causing the screw to be moved rearward to a predetermined metering position while being forwardly rotated and a pressure reducing step of reducing a pressure of the resin by rotating the screw in reverse based on the reverse rotation conditions that are predetermined,
the reverse rotation condition estimating apparatus comprising:
a learning model storage unit configured to store a learning model configured to estimate the reverse rotation conditions;
an acquisition unit configured to acquire a predetermined time series data set supplied from the injection molding machine at least during the pressure reducing step; and
an estimation unit configured to estimate the reverse rotation conditions using the predetermined time series data set acquired by the acquisition unit and the learning model stored in the learning model storage unit.

2. The reverse rotation condition estimating apparatus according to claim 1, further comprising a learning unit configured to generate or update the learning model by machine learning using the predetermined time series data set acquired by the acquisition unit.

3. The reverse rotation condition estimating apparatus according to claim 2, wherein the learning unit is configured to generate or update the learning model based on at least one of supervised learning, unsupervised learning, and reinforcement learning.

4. The reverse rotation condition estimating apparatus according to claim 3, wherein:
the learning unit is configured to generate the learning model by the supervised learning;
the learning model is a learning model configured to output a label corresponding to the predetermined time series data set acquired by the acquisition unit;
the reverse rotation condition estimating apparatus further includes a table storage unit configured to store a table indicating a relationship between the labels and the reverse rotation conditions; and
the estimation unit is configured to acquire the reverse rotation conditions associated with the label corresponding to the predetermined time series data set acquired by the acquisition unit, based on the table.

5. The reverse rotation condition estimating apparatus according to claim 1, wherein the reverse rotation conditions specify at least one of a rotation amount of the screw, a rotational acceleration of the screw, a rotational speed of the screw, and a rotation time of the screw.

6. The reverse rotation condition estimating apparatus according to claim 1, further comprising a display control unit configured to display on a display unit the reverse rotation conditions estimated by the estimation unit.

7. The reverse rotation condition estimating apparatus according to claim 1, wherein the injection molding machine further includes a reverse rotation condition storage unit configured to store the reverse rotation conditions, and a control unit configured to store, in the reverse rotation condition storage unit, the reverse rotation conditions estimated by the estimation unit during a current injection molding, as the reverse rotation conditions for a next injection molding.

8. The reverse rotation condition estimating apparatus according to claim 1, wherein the time series data set includes a time series data set on at least one of an electric current of a motor configured to drive the injection molding machine, a voltage applied to the motor, a torque of the motor, a rotation amount of the motor, a rotational acceleration of the motor, a rotation speed of the motor, a rotation time of the motor, a pressure of the resin, a temperature of the resin, a flow rate of the resin, and a flow velocity of the resin.

9. The reverse rotation condition estimating apparatus according to claim 1, wherein the acquisition unit is configured to acquire the predetermined time series data set supplied from at least one of a plurality of the injection molding machines connected by a network.

10. An injection molding machine equipped with the reverse rotation condition estimating apparatus according to claim 1.

11. A reverse rotation condition estimating method of estimating reverse rotation conditions of an injection molding machine, the injection molding machine including a cylinder into which a resin is supplied and a screw configured to move forward and rearward and rotate inside the cylinder, the injection molding machine being configured to perform at least a metering step of performing metering of the resin while the resin is being melted inside the cylinder, by causing the screw to be moved rearward to a predetermined metering position while being forwardly rotated and a pressure reducing step of reducing a pressure of the resin by rotating the screw in reverse based on the reverse rotation conditions that are predetermined,
the reverse rotation condition estimating method comprising:
an acquisition step of acquiring a predetermined time series data set supplied from the injection molding machine at least during the pressure reducing step; and
a step of estimating the reverse rotation conditions using the predetermined time series data set acquired at the acquisition step and a learning model configured to estimate the reverse rotation conditions.

12. The reverse rotation condition estimating method according to claim 11, further comprising a step of generating or updating the learning model by machine learning using the predetermined time series data set acquired at the acquisition step.

13. The reverse rotation condition estimating method according to claim 12, wherein the step of generating or updating the learning model generates or updates the learning model based on at least one of supervised learning, unsupervised learning, and reinforcement learning.

14. The reverse rotation condition estimating method according to claim 13, wherein:
the step of generating or updating the learning model generates the learning model by the supervised learning;
the learning model is a learning model configured to output a label corresponding to the predetermined time series data set acquired at the acquisition step; and,
the step of estimating the reverse rotation conditions acquires the reverse rotation conditions associated with the label corresponding to the predetermined time series data set acquired at the acquisition step, based on a table indicating a relationship between the labels and the reverse rotation conditions.

15. The reverse rotation condition estimating method according to claim 11, further comprising a step of storing, in a reverse rotation condition storage unit, the reverse rotation conditions estimated during a current injection molding, as the reverse rotation conditions for a next injection molding.
